(19) United States
(12) Patent Application Publication
(10) Pub. No.: US 2011/0090464 A1
(43) Pub. Date: Apr. 21, 2011

(54) PROJECTION APPARATUS

(75) Inventors: Ruei-Bin Jhang, Hsinchu (TW); Cheng-Shun Liao, Hsinchu (TW); Chu-Ming Cheng, Hsinchu (TW); Huang-Ming Chen, Hsinchu (TW); Chih-Hsien Tsai, Hsinchu (TW); S-Wei Chen, Hsinchu (TW)

(73) Assignee: YOUNG OPTICS INC., Hsinchu (TW)

(21) Appl. No.: 12/820,385

(22) Filed: Jun. 22, 2010

(30) Foreign Application Priority Data
Oct. 21, 2009 (TW) 98135645

(51) Int. Cl. G03B 21/28; G03B 21/14

(52) U.S. Cl. 353/31; 353/122; 353/38; 353/98; 353/81

(57) ABSTRACT

A projection apparatus includes at least one light source, a field lens, a light valve, and a projection lens. The light source provides an illumination beam. The field lens is disposed in a transmission path of the illumination beam including an effective beam passing through the field lens and a ghost beam reflected by the field lens. The effective beam forms a light spot on the light valve capable of converting the effective beam into an image beam. The projection lens is disposed in a transmission path of the image beam and a ghost beam path of the ghost beam. A center of the light spot does not overlap a center of the light valve. An offset direction from the light valve to an optical axis of the projection lens is the same as a direction from the center of the light valve to the center of the light spot.

### CROSS-REFERENCE TO RELATED APPLICATION

This application claims the priority benefit of Taiwan application Ser. No. 98135645, filed on Oct. 21, 2009. The entirety of the above-mentioned patent application is hereby incorporated by reference herein and made a part of specification.

### BACKGROUND OF THE INVENTION

1. Field of the Invention

The invention relates to a projection apparatus, and particularly, to a projection apparatus capable of diminishing ghost images.

2. Description of Related Art

In a conventional projection apparatus with a field lens structure, a problem hard to solve is when an illumination beam is directly reflected by the field lens to a projection lens without passing through a light valve, unexpected light spots (i.e. ghost images) on a screen then occurs due to the reflected illumination beam. So far, a solution replying to the aforesaid problem is to increase an offset of a light valve with respect to a projection lens, or by using an optical thin film coating to diminish stray light (i.e. ghost images) resulting from the illumination beam being directly reflected by the field lens.

However, the above method may at least have one of the following disadvantages. For the first method, the projection lens is difficult to design and the volume of the projection apparatus increases as well. In the second method, since the reflectivity of the optical thin film coating may not reach 0%, slight ghost images still occur, and the cost of the optical thin film coating is high.

On the other hand, several projection apparatuses are provided. Taiwan Patent No. 00491364 discloses a projection apparatus consisting of an illumination optical system and an image forming system. The illumination optical system includes a light source and an illumination system, and the image forming system includes a field lens, an image-forming lens set, a stop, and a screen. The projection apparatus further includes at least one blade disposed in front of a surface of the field lens facing the light source, so as to shield or absorb a reflected beam which results in ghost images.

Besides, Taiwan Patent No. 1264606 also discloses a projection apparatus mainly including a light source system, a micromirror device, an image forming lens set, and a light-shielding sheet. The light-shielding sheet is disposed between the micromirror device and the image forming lens set to shield bias light, such that ghost images resulting from the bias light during image formation of the projection apparatus are reduced.

Moreover, Taiwan Patent No. 00560186 and U.S. Pat. No. 6,557,9999 disclose an image projection system having a reflective imaging device and a projection device. The image projection system is characterized in a quarter wave plate provided between the reflective imaging device and projection lens to suppress reflections from the projection lens from reaching the reflective imaging device.

### SUMMARY OF THE INVENTION

The invention provides a projection apparatus in which, ghost images generated by the projection apparatus are diminished.

Other purposes and advantages of the invention can be further understood by referring to the technical features broadly embodied and described as follows.

An embodiment of the invention provides a projection apparatus including at least one light source, a field lens, a light valve, and a projection lens. The light source is capable of providing an illumination beam. The field lens is disposed in a transmission path of the illumination beam including an effective beam and a ghost beam. The transmission path of the illumination beam includes an effective beam path and a ghost beam path. The effective beam is capable of being transmitted along the effective beam path and passing through the field lens, and the ghost beam is capable of being transmitted along the ghost beam path and being reflected by the field lens. The light valve is disposed in the effective beam path of the effective beam capable of passing through the field lens and forming a light spot on the light valve. On the other hand, the light valve is capable of converting the effective beam into an image beam, and the image beam is capable of passing through the field lens. The projection lens is disposed in a transmission path of the image beam passing through the field lens and the ghost beam path of the ghost beam reflected by the field lens. A center of the light spot does not overlap a center of the light valve, and an offset direction of the light valve with respect to an optical axis of the projection lens is substantially the same as a direction from the center of the light valve to the center of the light spot.

Based on the above, in the embodiment of invention, the center of the light spot does not overlap the center of the light valve and the offset direction of the light valve with respect to the optical axis of the projection lens is substantially the same as the direction from the center of the light valve to the center of the light spot, such that unexpected light spots (i.e. ghost images) on a screen resulting from the ghost beam are reduced. In other words, since the overall area of the light spot on the light valve shifts downward, the ghost images on the screen are diminished.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional view of a projection apparatus according to the first embodiment of the invention.

FIG. 2 is a top view of the projection apparatus of FIG. 1.

FIG. 3 is a schematic top view of the light spot and the light valve along the negative x-direction of FIG. 1.

FIG. 4 is a schematic top view of a lens array module along the positive x-direction serving as the light uniforming element of FIG. 1.

FIG. 5 is a schematic top view of the projection lens, the field lens, and the light valve along the positive y-direction of FIG. 1.

FIG. 6 is a schematic top view of the light uniforming element and the lens group along the positive x-direction of FIG. 1.

FIG. 7 is another schematic top view of the light uniforming element and the lens group along the positive x-direction of FIG. 1.

FIG. 8 is a schematic top view of the light valve and the reflective unit along the negative x-direction of FIG. 1.

FIG. 9 is a schematic three-dimensional view of a projection apparatus according to the fourth embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

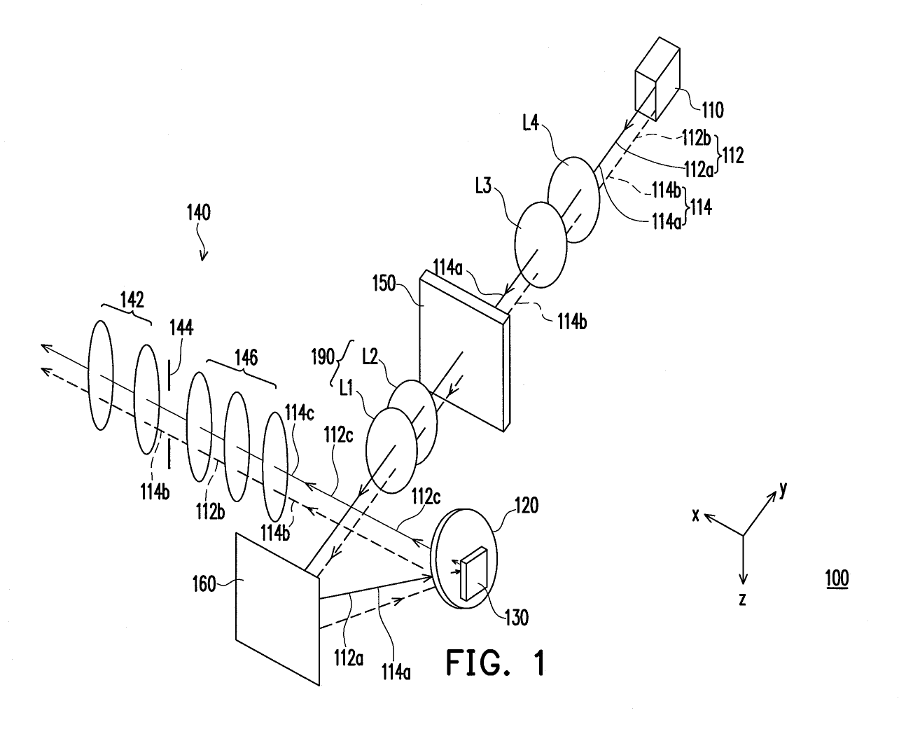

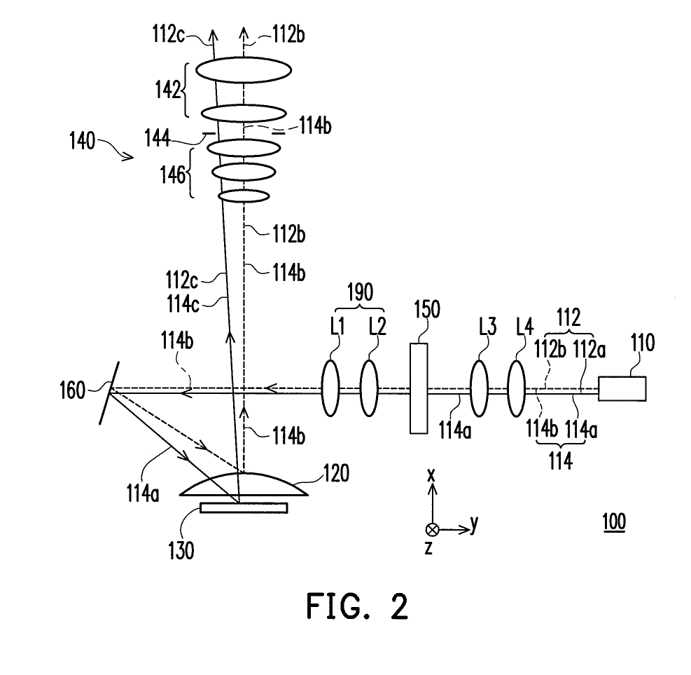

Referring to both FIG. 1 and FIG. 2, the projection apparatus 100 of the embodiment includes at least one light source 110 (only one is schematically shown in FIG. 1), a field lens 120, a light valve 130, and a projection lens 140.

The light source 110 is capable of providing an illumination beam 112. In the embodiment, the light source 110 is, for example, a light emitting diode (LED). However, in another embodiment, the light source 110 may be an ultra high pressure lamp (UHP lamp) or other appropriate light source. The field lens 120 is disposed in a transmission path 114 of the illumination beam 112 including an effective beam 112a and a ghost beam 112b. The transmission path 114 of the illumination beam 112 includes an effective beam path 114a and a ghost beam path 114b. As shown in FIGS. 1 and 2, the effective beam 112a is capable of being transmitted along the effective beam path 114a and passing through the field lens 120. The ghost beam 112b is capable of being transmitted along the ghost beam path 114b and being reflected by the field lens 120.

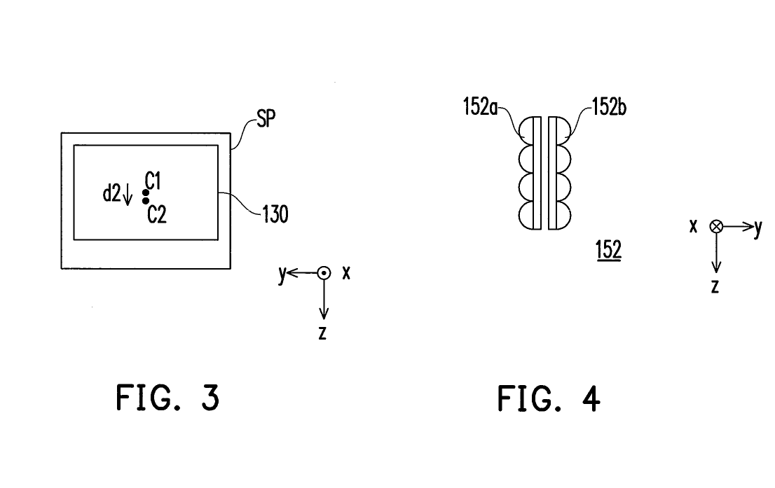

The light valve 130 is disposed in the effective beam path 114a of the effective beam 112a which passes through the field lens 120 and forms a light spot SP on the light valve 130 as shown in FIG. 3.

Referring to FIGS. 1 and 2, the light valve 130 is capable of converting the effective beam 112a into an image beam 112c, and the image beam 112c is capable of passing through the field lens 120. In the embodiment, the light valve 130, for example, is a digital micro-mirror device (DMD). However, in another embodiment, the light valve may be a liquid-crystal-on-silicon panel (LCOS panel).

As shown in FIGS. 1 and 2, the lens group 140 is disposed in a transmission path 114c of the image beam 112c passing through the field lens 120 and disposed in the ghost beam path 114b of the ghost beam 112b reflected by the field lens 120. Beside, the projection lens 140 of the embodiment may include two lens groups 142 and 146, and an aperture stop 144, and the invention is not limited to it. In the embodiment, the lens groups 142 and 146 are disposed in a transmission path 114c of the image beam 112c passing through the field lens 120 and the ghost beam path 114b of the ghost beam 112b reflected by the field lens 120. Furthermore, the aperture stop 144 is disposed in the transmission path 114c of the image beam 112c and the ghost beam path 114b of the ghost beam 112b reflected by the field lens 120, and located between the two lens groups 142 and 146.

Besides, the projection apparatus 100 of the embodiment may further include a lens group 190 and a light uniforming element 150, wherein the lens group 190 includes at least one lens two lenses L1 and L2 are schematically shown in FIG. 1). The lens group 190 is disposed in the effective beam path 114a and the ghost beam path 114b, and located between the light source 110 and the field lens 120. The light uniforming element 150 is disposed in the effective beam path 114a and the ghost beam path 114b, and located between the light source 110 and the lens group 190. In the embodiment, the light uniforming element 150 is, for example, a lens array module or a light integration rod. FIG. 4 shows a lens array module 152 along the positive x-direction serving as the light uniforming element 150. As shown in FIG. 4, the lens array module 152 includes two lens arrays 152a and 152b capable of uniformizing the illumination beam 112 after the illumination beam 112 passes through the lens array module 152.

Besides, the projection apparatus 100 of the embodiment also includes a reflective unit 160. The reflective unit 160 is disposed in the transmission path 114 of the illumination beam 112, and located between the light source 110 and the field lens 120, so as to reflect the illumination beam 112 from the light source 110 to the field lens 120. The ghost beam 112b of the illumination beam 112 is reflected by the field lens 120, and the effective beam 112a of the illumination beam 112 passes through the field lens 120 and is transmitted to the light valve 130. Then, the effective beam 112a passing through the light valve 130 is converted into the image beam 112c carrying image information. When the image beam 112c passes through the projection lens 140 to a screen (not shown), an image (not shown) is generated on the screen. On the other hand, the projection apparatus 100 of the embodiment further includes lenses L3 and L4 disposed between the light uniforming element 150 and the light source 110. The illumination beam 112 is capable of being transmitted to the light uniforming element 150 at an appropriate angle after passing through the lenses L3 and L4.

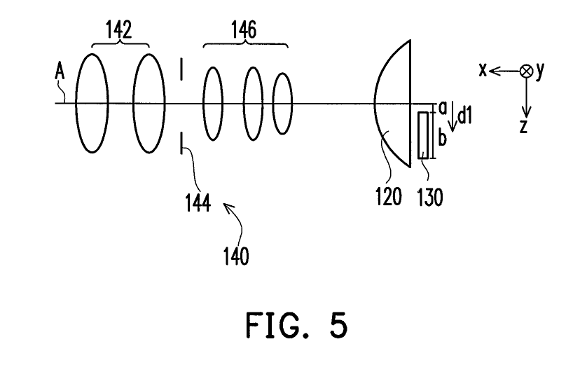

As shown in FIG. 5, there is an offset direction d1 (i.e. along the positive z-direction) of the light valve 130 with respect to an optical axis A of the projection lens 140. On the other hand, a center C2 of the light spot SP does not overlap a center C1 of the light valve 130 as shown in FIG. 3, and a direction from the center C1 of the light valve 130 to the center C2 of the light spot SP is defined as d2 (i.e. along the positive z-direction).

Thus, referring to both FIGS. 3 and 5, the offset direction d1 (i.e. the positive z-direction in FIG. 5) of the light valve 130 with respect to the optical axis A of the projection lens 140 is substantially the same as the direction d2 (i.e. the positive z-direction in FIG. 3) from the center C1 of the light valve 130 to the center C2 of the light spot SP. Besides, a scope of the light spot SP covers the light valve 130. By changing a distance between the center C2 of the light spot SP and the center C1 of the light valve 130 along the direction d2, ghost images on a screen resulting from the ghost beam 112b (shown in FIGS. 1 and 2) are diminished.

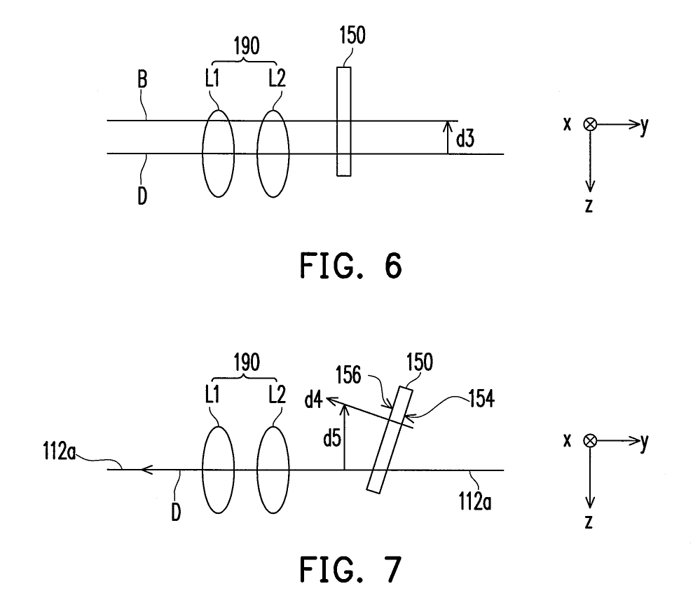

Referring to both FIGS. 3 and 6, in the embodiment, an offset direction d3 (i.e.

the negative z-direction) of an optical axis B of the light uniforming element 150 with respect to an optical axis D of the lens group 190 is substantially opposite to the direction d2 (i.e. the positive z-direction) from the center C1 of the light valve 130 to the center C2 of the light spot SP in FIG. 3. From another point of view, an offset direction of the optical axis D of the lens group 190 with respect to the optical axis B of the light uniforming element 150 (i.e. opposite to the direction d3) is substantially the same as the direction d2 (i.e. the positive z-direction) from the center C1 of the light valve 130 to the center C2 of the light spot SP.

It should be noted that, after the illumination beam 112 (shown in FIG. 1) passes through the light uniforming element 150 and the lens group 190, the position of the light spot SP projecting on the light valve 130 varies with the relative positions of the light uniforming element 150 and the lens group 190. Specifically, while the z coordinate of the optical axis B is smaller than the z coordinate of the optical axis D (the optical axis B is higher than the optical axis D), the z coordinate of the center C2 of the light spot SP is bigger than the z coordinate of the center C1 of the light valve 130. That is to say, the center C2 of the light spot SP is shifted toward along the positive z-direction farther away from the center C1 of the light valve 130. As a whole, the light spot SP on light valve 130 shifts downward such that ghost images on a screen (not shown) resulting from the ghost beam 112b are reduced.

Thus, by adjusting the relative positions of the optical axis B of the light uniforming element 150 and the optical axis D of the lens group 190 so as to change the distance along the direction d2 between the center C1 of the light valve 130 and the center C2 of the light spot SP, unexpected light spots (ghost images) on a screen (not shown) resulting from the ghost beam 112b (shown in FIGS. 1 and 2) are diminished. As a result, ghost images are reduced without increasing the offset of the light valve 130 with respect to the optical axis A (as shown in FIG. 5) of the projection lens 140. Since the offset of the light valve 130 is not increased, the sizes of lenses in the projection lens 140 need not to be increased, such that the volume of the projection lens is reduced. Besides, the light uniforming element 150 may be, for example, the lens array module 152 of FIG. 4 or a light integration rod.

On the other hand, in another embodiment, the distance along the direction d2 between the center C1 of the light valve 130 and the center C2 of the light spot SP may be changed by adjusting the relative positions of the light source 110 and the light uniforming element 150, such that unexpected light spots (ghost images) on a screen (not shown) are diminished.

### Second Embodiment

Referring to FIG. 7, the major difference between FIG. 7 and FIG. 6 is describe as following. The light uniforming element 150 of FIG. 7 tilts with respect to the optical axis D of the lens group 190. As shown in FIG. 7, the light uniforming element 150 has a light incident end 154 and a light emitting end 156 opposite to each other. The effective beam 112a enters the light uniforming element 150 through the light incident end 154 and leaves the light uniforming element 150 from the light emitting end 156. An offset direction d5 (i.e. the negative z-direction) of the direction d4 from the light incident end 154 to the light emitting end 156 with respect to the optical axis D of the lens group 190 is substantially opposite to the direction d2 (i.e. the positive z-direction) from the center C1 of the light valve 130 to the center C2 of the light spot SP. In the embodiment, the whole scope of light spot SP on the light valve 130 also shifts downward (i.e. along the positive z-direction) by tilting the light uniforming element 150, such that ghost images on a screen (not shown) resulting from the ghost beam 112b are diminished. On the other hand, the light uniforming element 150 of FIG. 7 is, for example, the lens array module 152 of FIG. 4 or a light integration rod.

### Third Embodiment

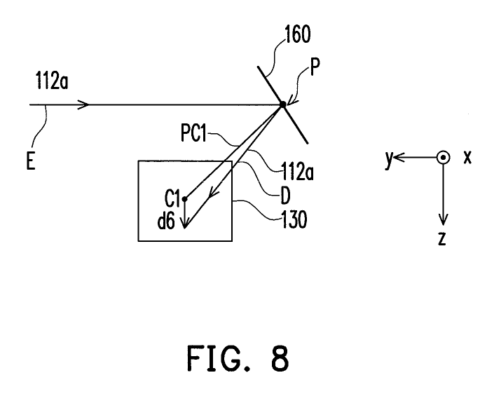

Referring to both FIGS. 1 and 8, the reflective unit 160 is disposed in the transmission path 114 of the illumination beam 112 and located between the light source 110 and the field lens 120, so as to reflect the illumination beam 112 to the field lens 120. In the embodiment, a shortest connecting line from an intersection P of an optical axis E of the effective beam 112a and the reflective unit 160 to the center C1 of the light valve 130 is defined as a reference connecting line PC1.

As shown in FIG. 8, there is an offset direction d6 of the optical axis E of the effective beam 112a reflected by the reflective unit 160 with respect to the reference connecting line PC1. Since the optical axis E of the effective beam 112a does not overlap the reference connecting line PC1 and an offset is between the optical axis E of the effective beam 112a and the reference connecting line PC1, the center C2 of the light spot SP of FIG. 3 does not overlap the center C1 of the light valve 130. In other words, the offset direction d6 of the optical axis E of the effective beam 112a reflected by the reflective unit 160 with respect to the reference connecting line PC1 is substantially the same as the direction from the center C1 of the light valve 130 to the center C2 of the light spot SP of FIG. 3. Thus, the whole scope of light spot SP on the light valve 130 also shifts downward (i.e. along the positive z-direction) by adjusting a tilting angle of the reflective unit 160 so as to change the optical axis E of the effective beam 112a, such that ghost images on a screen (not shown) resulting from the ghost beam 112b are diminished.

### Fourth Embodiment

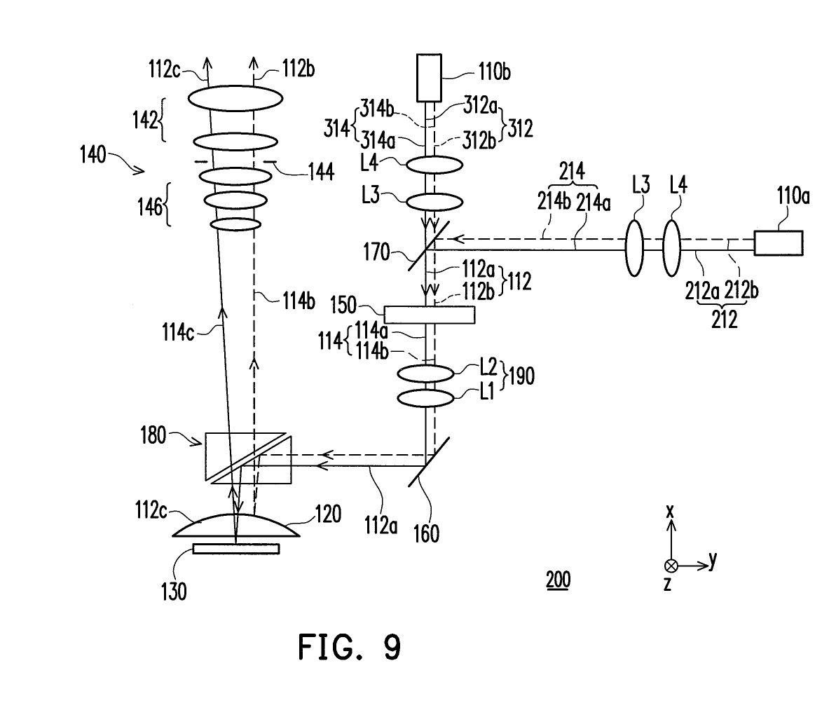

Referring to FIG. 9 the projection apparatus 200 of the embodiment is similar to the projection apparatus 100 of FIG. 2, the major difference between the projection apparatus 200 and the projection apparatus 100 of FIG. 2 is describe as following. The projection apparatus 200 includes a plurality of light sources 110a and 110b (only two light source are schematically shown in FIG. 9), a beam combining unit 170, and a total internal reflection (TIR) prism 180.

The light combining unit 170 of the embodiment is, for example, a dichroic unit, and colors of the illumination beams 212 and 312 of the light sources 110a and 110b are different from each other. The beam combining unit 170 is disposed in a transmission path 214 of an illumination beam 212 provided by the light source 110a and a transmission path 314 of the illumination beam 312 provided by the light source 110b. Besides, the beam combining unit 170 is located between each of the light sources and the field lens 120, so as to combine the transmission paths 214 and 314 of the illumination beams 212 and 312 and form an illumination beam 112 the same as the illumination beam of FIG. 2, wherein the illumination beam 112 includes the effective beam 112a and the ghost beam 112b.

Specifically, the beam combining unit 170 reflects the effective beam 212a and the ghost beam 212b from the light source 110a to the light uniforming element 150. Then, the effective beam 312a and the ghost beam 312b from the light source 110b is capable of passing through the beam combining unit 170 and being transmitted to the light uniforming element 150. Thus, the illumination beam 112 the same as the illumination beam of FIG. 2 is formed.

Then, the reflective unit 160 reflects the illumination beam 112 to the TIR prism 180. The TIR prism 180 is disposed in a transmission path 114 of the illumination beam 112, and located between the light source 110a (or the light source 110b) and the field lens 120.

As shown in FIG. 9, the effective beam 112a sequentially passes through the field lens 120 and the light valve 130 after being totally reflected by the TIR prism 180, such that the image beam 112c is generated. Then, the image beam 112c is capable of being transmitted from the TIR prism 180 to the projection lens 140 after passing through the field lens 120, such that an image (not shown) is formed on a screen (not shown). In brief, in terms of the transmission path of a beam, the TIR prism 180 is disposed in the transmission path 114c of the image beam 112c and located between the field lens 120 and the projection lens 140.

On the other hand, the projection apparatus 200 of the embodiment includes two lenses L3 and two lenses L4 respectively corresponding to the light sources 110a and 110b. In addition, the relative positions of the lenses L1 and L2 and the light uniforming element 150 may be deduced by referring to FIG. 6 or FIG. 7, and detailed descriptions are omitted. Moreover, the relative positions of the reflective unit 160 and the lens group 190 may be also deduced by referring to FIG. 8, and detailed descriptions are omitted as well.

In brief, both the relative positions of the lenses L1 and L2 and the light uniforming element 150 and the relative positions of the reflective unit 160 and the lens group 190 are adjusted to make the whole range of the light spot SP on the light valve 130 shift downward, such that ghost images on a screen (not shown) resulting from the ghost beam 112b are diminished.

In summary, the embodiment or the embodiments of invention may have at least one of the following advantages. The center of the light spot does not overlap the center of the light valve and the offset direction of the light valve with respect to the optical axis of the projection lens is substantially the same as the direction from the center of the light valve to the center of the light spot, such that unexpected light spots (i.e. ghost images) on a screen resulting from the ghost beam are reduced. In other words, since the overall scope of the light spot on the light valve shifts downward, the ghost images on the screen are diminished.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
at least one light source, capable of providing an illumination beam;
a field lens, disposed in a transmission path of the illumination beam wherein the illumination beam comprises an effective beam and a ghost beam, the transmission path of the illumination beam comprises an effective beam path and a ghost beam path, the effective beam is capable of being transmitted along the effective beam path and passing through the field lens, and the ghost beam is capable of being transmitted along the ghost beam path and being reflected by the field lens;
a light valve, disposed in the effective beam path of the effective beam capable of passing through the field lens and forming a light spot on the light valve, wherein the light valve is capable of converting the effective beam into an image beam and the image beam is capable of passing through the field lens; and
a projection lens, disposed in a transmission path of the image beam passing through the field lens and the ghost beam path of the ghost beam reflected by the field lens, wherein a center of the light spot does not overlap a center of the light valve, and an offset direction of the light valve with respect to an optical axis of the projection lens is substantially the same as a direction from the center of the light valve to the center of the light spot.

2. The projection apparatus of claim 1, further comprising:
a lens group, disposed in the effective beam path and the ghost beam path, and located between the light source and the field lens; and
a light uniforming element, disposed in the effective beam path and the ghost beam path, and located between the light source and the lens group.

3. The projection apparatus of claim 2, wherein the light uniforming element is a lens array module or a light integration rod.

4. The projection apparatus of claim 2, wherein the lens group comprises at least one lens.

5. The projection apparatus of claim 2, wherein an offset direction of an optical axis of the light uniforming element with respect to an optical axis of the lens group is substantially opposite to the direction from the center of the light valve to the center of the light spot.

6. The projection apparatus of claim 5, wherein the light uniforming element has a light incident end and a light emitting end opposite to each other, the effective beam is capable of entering the light uniforming element through the light incident end, and is capable of leaving the light uniforming element from the light emitting end.

7. The projection apparatus of claim 1, further comprising a reflective unit, disposed in the transmission path of the illumination beam and located between the light source and the field lens, so as to reflect the illumination beam to the field lens, wherein a shortest connecting line from an intersection of an optical axis of the effective beam and the reflective unit to the center of the light valve is defined as a reference connecting line and an offset direction of the optical axis of the effective beam reflected by the reflective unit with respect to the reference connecting line is substantially the same as the direction from the center of the light valve to the center of the light spot.

8. The projection apparatus of claim 1, further comprising a total internal reflection prism, disposed in the transmission path of the illumination beam, and located between the light source and the field lens, wherein the total internal reflection prism is disposed in the transmission path of the image beam, and located between the field lens and the projection lens.

9. The projection apparatus of claim 1, wherein a scope of the light spot covers the light valve.

10. The projection apparatus of claim 1, wherein the at least one light source is a plurality of light sources, and the projection apparatus further comprises a beam combining unit disposed in transmission paths of illumination beams respectively provided by the light sources, and located between each of the light sources and the field lens, so as to combine the transmission paths of the illumination beams.

11. The projection apparatus of claim 10, wherein the light combining unit is a dichroic unit, and colors of the illumination beams of the light sources are different from one another.

12. The projection apparatus of claim 1, wherein the light valve is a digital micro-mirror device or a liquid-crystal-on-silicon panel.
